(19) United States
(12) Patent Application Publication
(10) Pub. No.: US 2014/0342051 A1
(43) Pub. Date: Nov. 20, 2014

(54) FILLED FLATBREAD FOOD PRODUCT AND METHODS OF PREPARATION

(71) Applicants: Julio Rendon, Visalia, CA (US); Russell Allan Meigs, Clovis, CA (US); Luis Munguia, Orosi, CA (US); Kathleen Da Cunha, Fresno, CA (US)

(72) Inventors: Julio Rendon, Visalia, CA (US); Russell Allan Meigs, Clovis, CA (US); Luis Munguia, Orosi, CA (US); Kathleen Da Cunha, Fresno, CA (US)

(73) Assignee: Ruiz Food Products, Inc., Dinuba, CA (US)

(21) Appl. No.: 14/283,124

(22) Filed: May 20, 2014

Related U.S. Application Data
(60) Provisional application No. 61/825,366, filed on May 20, 2013.

(51) Int. Cl. A21D 13/00

(52) U.S. Cl. CPC A21D 13/0019
USPC 426/94; 426/275

(57) ABSTRACT

A flatbread food product including a first flatbread having a first side and a second side. A filling is positioned on the first side of the flatbread. The food product further including a second flatbread having a first side and a second side, wherein the first side of the second flatbread faces the filling and is sealed to the first side of the first flatbread such that the filling is sealed between the first flatbread and the second flatbread.

### CROSS-REFERENCE TO RELATED APPLICATION

This application claims priority from U.S. Provisional Patent Application Ser. No. 61/825,366, filed on May 20, 2013 and incorporated herein by reference.

### FIELD

A filled flatbread food product and method for preparing the same; more specifically, a filled tortilla food product. Other embodiments are also described and claimed.

### BACKGROUND

A flatbread is a type of bread product typically made with flour, water, and salt and then pressed into flattened dough. Many flatbreads are unleavened, meaning that they are made without yeast or sourdough culture. Some flatbreads, such as pita bread, however, may be made with yeast. A tortilla is a type of flatbread typically made with corn or flour as the primary ingredient. Tortillas and flatbreads in general, are commonly folded or rolled around a filling to make a variety of food dishes, for examples, tacos, burritos and enchiladas. Tortillas can also be used to make other food dishes such as quesadillas, which consist of a layer of cheese or other filling sandwiched between two tortillas. In any of these uses, however, the tortilla(s) is not sealed around the edges and, therefore, the filling typically leaks out during consumption.

### SUMMARY

A filled flatbread food product is disclosed herein which includes two baked flatbreads with a filled center which will not leak, burst or become deformed when reheated. The flatbreads may be tortillas with a layer of food filling sandwiched in between. The flatbreads may be sealed together with a food grade sealant. Sealing of the flatbreads around the filling prevents the filling inside from leaking out when the product is exposed to heating such as in a fryer, or other cooking process. The filling could include multiple components or be comprised of just one comestible such as a cheese or a cheese mixture. In addition, one or more of the flatbreads may be docked before or after the food product is assembled to prevent deformation of the food product during further cooking operations that may be performed on the assembled food product. Once assembled, the filled flatbread product can then be formed in a fryer basket or other mold, such as into a U shaped taco shell or bowl, and heated to seal and crisp the flatbreads. This resulting crispy shell can then be filled with various foods including but not limited to meat, cheese and vegetables to create a multilayer flatbread food product.

In one embodiment, the filled flatbread food product may be formed by laying out one flatbread (e.g., tortilla) into a first layer and applying a food grade sealant to an exposed surface of the first flatbread layer. A filling may then be applied to the exposed surface of the flatbread layer. A second flatbread may be placed over the first flatbread and the filling to form a second flatbread layer over the first flatbread layer and the filling. Pressure may be applied to the layers to form a filled flatbread food product that is sealed around the filling. In some cases, one or both of the flatbreads may be docked to form holes within its surface so as to prevent formation of bubbles in the flatbread during a cooking process. The filled flatbread food product may be frozen as a substantially flat food product or formed into another shape and then cooked (e.g., fried or baked) to mold the food product into the desired shape.

### BRIEF DESCRIPTION OF THE DRAWINGS

The following illustration is by way of example and not by way of limitation in the figures of the accompanying drawings in which like references indicate like elements. It should be noted that references to “an” or “one” embodiment in this disclosure are not necessarily to the same embodiment, and such references mean at least one.

FIG. 1 illustrates an exploded perspective view of one embodiment of a filled flatbread food product.

FIG. 2 illustrates a cross-sectional side view of one embodiment of a filled flatbread food product.

FIG. 3 illustrates a cross-sectional side view of one embodiment of a filled flatbread food product.

FIG. 4 illustrates a cross-sectional side view of one embodiment of a filled flatbread food product.

FIG. 5 illustrates a cross-sectional side view of one embodiment of a filled flatbread food product.

FIG. 6 illustrates a flow diagram of one embodiment of a process for forming a filled flatbread food product.

### DETAILED DESCRIPTION

In this section we shall explain several preferred embodiments of this invention with reference to the appended drawings. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known structures and techniques have not been shown in detail so as not to obscure the understanding of this description.

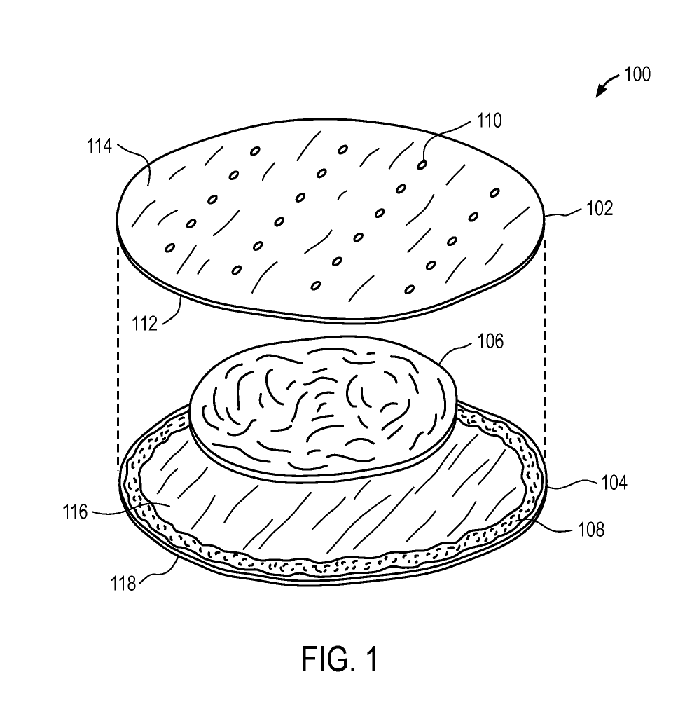

FIG. 1 illustrates an exploded perspective view of one embodiment of a filled flatbread food product. Filled flatbread food product 100 may include a first flatbread 102, a second flatbread 104 and a filling 106 sealed between first flatbread 102 and second flatbread 104. Flatbreads 102, 104 may be any type of flatbread. For example, in one embodiment, one or more of flatbreads 102, 104 may be a tortilla, such as a flour or corn (e.g. white or yellow corn) tortilla. In other embodiments, one or more of flatbreads 102, 104 may be pita bread or any other type of flatbread, or combinations of different types of flatbreads. In some embodiments, flatbreads 102, 104 may be substantially round breads having a diameter of from about 2 inches to about 16 inches, or from 4 inches to about 12 inches, for example, from 5 inches to 10 inches, or from 6 inches to about 6.5 inches. In still further embodiments, flatbreads 102, 104 may have other shapes and sizes, or be cut into other shapes and sizes after processing. Representative shapes could include oval, square, rectangular or triangular shapes having any of the above described cross-sectional dimensions. Flatbreads 102, 104 may have any thickness typical of a flatbread product. Flatbread 102 may include an inner surface or side 112 and an outer surface or side 114. Similarly, flatbread 104 may include an inner surface of side 116 and an outer surface or side 118. Flatbreads 102, 104 may be cooked prior to assembly of flatbread food product 100. It is contemplated, however, that in some embodiments, flatbreads 102, 104 may be assembled into flatbread food product 100 in an uncooked state.

In some embodiments, one or more of flatbreads 102, 104 may be docked to form holes 110 through an exterior surface or side 114, 118 of one or more of flatbreads 102, 104. Holes 110 facilitate post cooking procedures which may be performed on flatbread food product 100. In particular, holes 110 prevent the formation of bubbles in the flatbread so that the food product maintains its shape when heated (e.g., baked or fried). In particular, the docking process prevents the formation of cavities during the heating process. Docking may be critical to formation of a shaped flatbread food product 102, 104, as will be described in more detail below. In particular, thinner flatbreads such as tortillas are baked very quickly at high temperatures. As a result, such flatbreads tend to have high moisture content and often an incompletely baked crumb body. When these pre-cooked flatbreads are then exposed to intense heat such as the superheated conditions of a submersion fryer, they swell rapidly and become distorted in shape. This distortion is reduced, and in some cases eliminated, in the case of flatbread food product 100 by providing escape holes 110 for the expanding steam and gas formed during the heating process. Holes 110 may be formed in one or more of flatbreads 102, 104 prior to or after the formation of flatbread food product 100. It should further be recognized that holes 110 are formed in flatbreads 102, 104 after they are already cooked in order to eliminate bubbling of the cooked flatbread during a second cooking operation (e.g., frying step), not to prevent bubbling of a raw flatbread dough during an initial cooking step.

While the previously discussed mechanical docking creates the conditions necessary to assure the release of expanding gas, it is also possible to solve the gas retention problem with the assistance of the flatbread dough formulation itself. In some cases, the addition of docking agents such as particulates to the dough formula can cause ruptures and physical penetrations of the dough structure which remain functional after the initial baking process. Examples of this type of “formulation docking” include the addition of docking components or agents such as granules of fat and/or coarsely ground flours such as corn meal, farina and rice or corn grits to the flatbread dough. Formulation docking may be used in addition to mechanical docking, or instead of mechanical docking Representatively, in one embodiment, where formulation docking is desired, the flatbread dough may consist of the following formulation:

Formulation I

| Ingredient | Amount |
|---|---|
| Bread Flour | Up to 100 |
| Water | 46-56 |
| Shortening or oil | 6-12 |
| Salt | 0.50-2.50 |
| Sodium Stearoyl Lactylate | 0-0.50 |
| Sodium Metabisulfite | 0-90 ppm |
| Mono and Diglycerides | 0-1.0 |
| Sorbic Acid | 0-1.0 |
| L-Cysteine | 0-90 ppm |
| Baking Powder | 0-3 |
| Yeast | 0-3 |
| Docking component | 0-25 |

The ingredient amounts listed in Formulation I are in weight percent of the total dough composition except where otherwise indicated.

Filling 106 may be any type of edible filling capable of forming a layer between flatbreads 102, 104. Representatively, filling 106 could be a complex mixture of different ingredients or could be a single ingredient. Suitable ingredients may include, but are not limited to, cheese, water, starches, seasonings, vegetables and meat, as well as protein extenders. In one or more embodiments, these ingredients can be used to form a patty which would approximate the dimensions of flatbreads 102, 104 while leaving an exposed outer surface for proper sealing. For example, where flatbreads 102, 104 are circular flatbreads, filling 106 may be formed into a substantially circular patty having a diameter slightly less than that of flatbreads 102, 104, for example, less than 12 inches, less than 10 inches, or from about 5 inches to about 5.5 inches. The thickness of filling 106 should be uniform so that the top flatbread, e.g., flatbread 102, will rest evenly across the patty and make contact with the lower flatbread, e.g., flatbread 104, when applying pressure to the outer edges of flatbreads 102, 104.

Flatbread food product 100 may also include a sealant 108 applied to an exposed surface of one or more of flatbreads 102, 104. In some embodiments, sealant 108 may be applied around the edges of an inner surface or side 112, 116 of flatbreads 102, 104, respectively, while in other embodiments sealant 108 may be applied over an entire surface of flatbreads 102, 104. Sealant 108 may be any type of food grade sealant capable of physically bonding one of flatbreads 102, 104 to the other of flatbreads 102, 104. Since flatbreads 102, 104 are already cooked (e.g., baked), the naturally occurring starches and proteins of the dough are largely inactivated. Sealant 108 should therefore supply a heat/time activated bonding agent which prevents filling 106 from leaking out between flatbreads 102, 104 when they are sealed together. Representatively, in one embodiment, sealant 108 may be composed of flour or starch based adhesives. In addition, a gum based adhesive could be used either alone or in combination with starch or flour adhesives to form sealant 108. Gums can be sourced from a number of natural and artificial sources. An example of these gums might include sodium alginate, guar gum, cellulose gum and xanthan gum. The starch adhesives gelatinize upon heating to form a tight seal between the two flatbreads 102, 104. In one preferred embodiment, sealant 108 could include a mixture of pre-gelatinized and un-gelatinized starches from potato, wheat, rice, corn or other plant sources. These starches could be modified to enhance their adhesive properties. However, even native starches and unmodified flours provide some degree of adhesiveness and may be included in sealant 108. In any case, it was surprisingly found that when flatbreads 102, 104 having sealant 108 therein were pressed together, not only did sealant 108 seal the cooked flatbreads 102, 104 together in the absence of heat, but the seal was maintained during subsequent cooking processes of flatbread food product 100 (e.g., frying). The sealant is absorbed into the surface crust of the two baked flat breads physically bonding them together. Then when the flatbread food is introduced to heat the absorbed un-gelatinized starch blooms and chemically bonds the two fully baked flatbreads together. This results in a tight seal which prevents leaking.

Thus, the assembled flatbread food product 100 results in a multilayered flatbread shell which can be easily handled during any subsequent heating process. In particular, since filling 106 is sealed between the interfacing sides 112, 116 of flatbreads 102, 104, respectively, the filling does not ooze out the sides of flatbreads 102, 104 when heated, for example during a deep fat frying process. In this aspect, the filled flatbread food product 100 can be formed into a variety of shapes and sizes and fried (or baked) into the desired shape without distortion or leaking of filling 106.

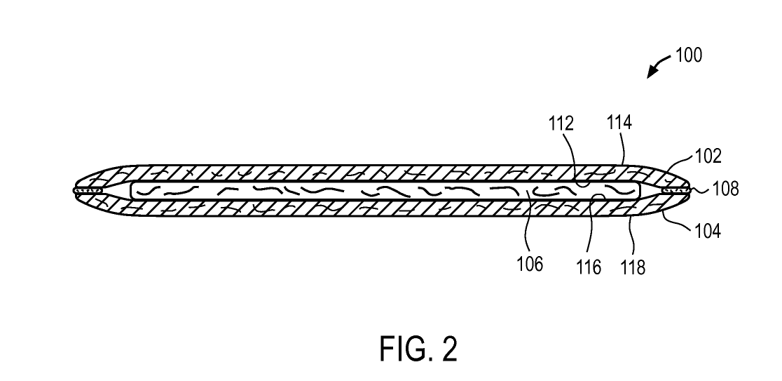

FIG. 2 illustrates a cross-sectional side view of one embodiment of a filled flatbread food product. From this view it can be seen that sealant 108 is positioned between edges of flatbreads 102, 104 and filling 106 is sealed between flatbreads 102, 104. Since filling 106 is sealed between flatbreads 102, 104 it will not leak out of flatbread food product 100 during subsequent processing.

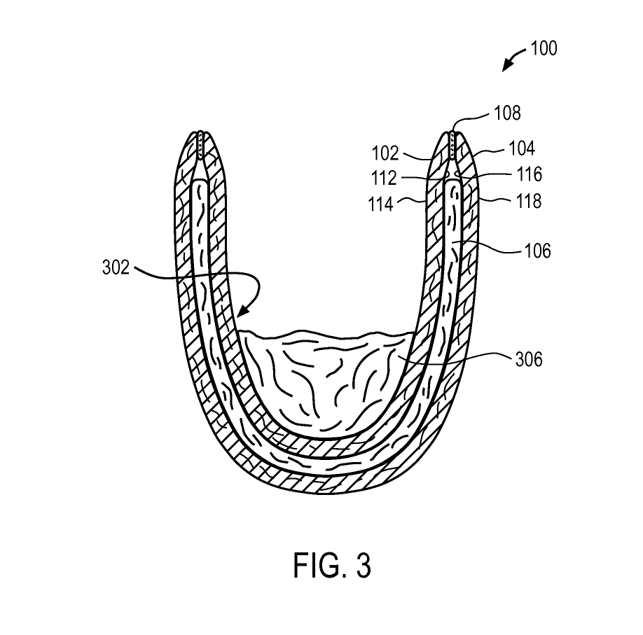

Representatively, FIG. 3 illustrates a cross-sectional side view of one embodiment of a filled flatbread food product having a molded shape. In particular, FIG. 3 illustrates flatbread food product 100 after it has been molded into a shaped suitable for holding a second filling 306. Representatively, flatbread food product 100 has been formed into a U shape by folding opposing sides of flatbread food product 100 towards one another and then frying or baking flatbread food product 100 to retain this shape. For example, in one embodiment, the flatbread food product 100 as illustrated in FIG. 2 may be inserted into a mold, such as a pre-formed basket which has U shaped slots. Once within the mold, the mold may be placed within a fryer, or oven, which cooks flatbread food product 100 into a U shape such as that illustrated in FIG. 3. Cooking of flatbread food product 100 results in a flatbread food product 100 having a crispy flatbread shell which maintains the U shape and is composed of multiple layers of flatbreads 102, 104 and filling 306. A pocket 302 formed within flatbread food product 100 may then be used to hold a second filling 306. The second filling 306 may be any one or more of the previously discussed fillings, or another type of food filling suitable for eating within a filled flatbread food product 100. For example, the molded flatbread food product 100 may be used to assemble a taco having a meat, lettuce, tomato and cheese filling within pocket 306.

It is to be understood that although a flatbread food product molded into a U shaped configuration is illustrated, any other shape suitable for holding a filling is contemplated. For example, flatbread food product 100 may be molded into a bowl-shaped configuration or any other configuration suitable for holding a filling.

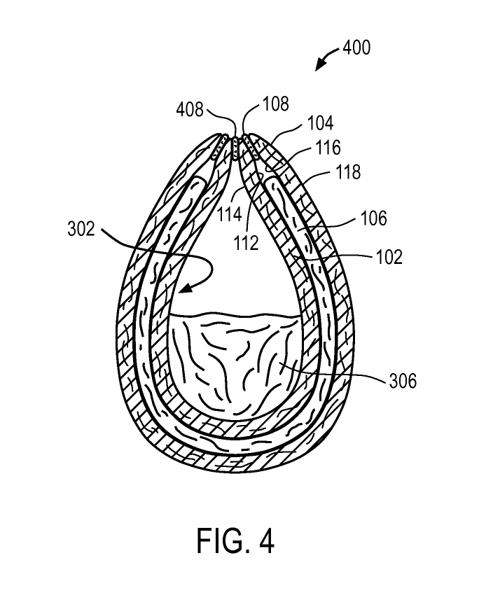

FIG. 4 illustrates a cross-sectional side view of one embodiment of a filled flatbread food product. Flatbread food product 400 is substantially similar to the flatbread food product described in reference to FIG. 3 except that in this embodiment, a further sealant 408 is applied to the interfacing sides of the filled flatbread food product 400 such that the folded sides are also sealed together. Sealant 408 may be applied around the entire edge region of the interfacing sides so that the edges are completely sealed around filling 306. In this aspect, pocket 302 is sealed around filling 306 so that both filling 106 and filling 306 are sealed within the flatbread food product and prevented from leaking out during any further processing operations (e.g., heating).

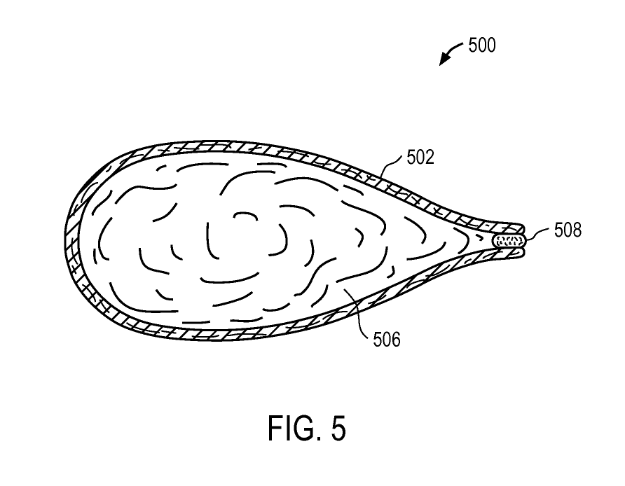

FIG. 5 illustrates a cross-sectional side view of one embodiment of a filled flatbread food product. Flatbread food product 500 includes a single flatbread 502 folded around filling 506 and sealed to itself using a sealant 508. Sealant 508 may be applied around the entire edge of flatbread 502 such that filling 506 is completely sealed within flatbread 502.

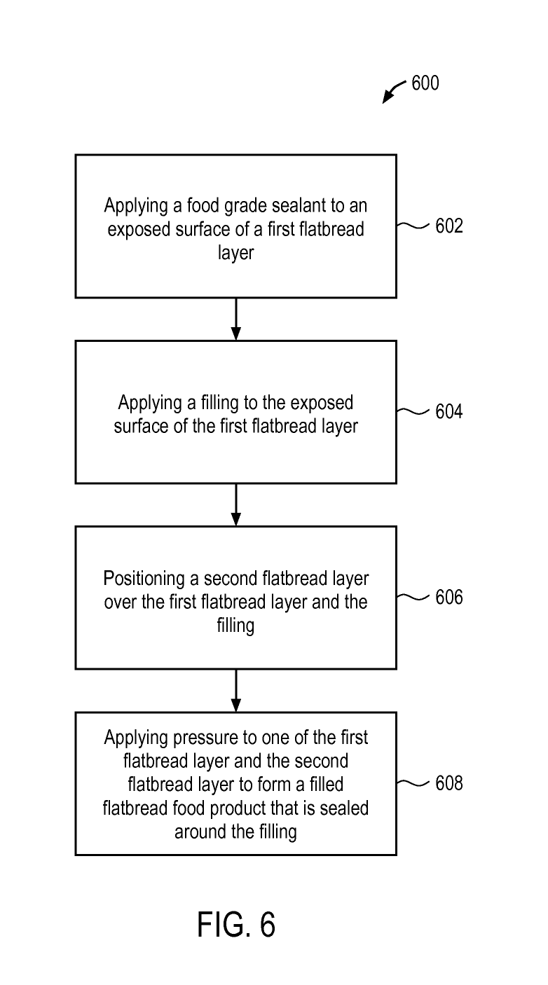

One embodiment of a process for assembling the flatbread food product will now be described in reference to FIG. 6. Process 600 may include placing a single flatbread on a flat surface to form a first flatbread layer and applying a food grade sealant to an exposed surface of the first flatbread layer <block 602>. The sealant may be applied around only the edges of the first flatbread layer or the entire exposed surface of the flatbread layer. A filling may be applied to the exposed surface of the first flatbread layer <block 604>. The filling may be applied over substantially the entire exposed surface of the first flatbread layer except edges portions of the flatbread. It is further noted that in some embodiments, the sealant may also be applied over the filling to further enhance sealing of the filling within the flatbread food product. Once the filling and sealant are in place, a second flatbread layer is positioned over the first flatbread layer and the filling such that the filling is sandwiched between the first flatbread layer and the second flatbread layer <block 606>. To seal the flatbread layers together and around the filling, pressure is applied to one of the first flatbread layer or the second flatbread layer <block 608>. The pressure may be applied to the edges of the flatbread layers to ensure the edges are bonded together around the filling.

In further process steps, one or both of the flatbread layers may be docked to form holes through the exterior surfaces of the filled flatbread food product. As previously discussed, the holes prevent the formation of bubbles in the flatbread so that the filled flatbread food product maintains its shape when heated. The flatbread layers may be docked after the flatbread food product is assembled or prior to assembly. In some embodiments, the filled flatbread food product may be uniformly flattened to create an even flat surface without any air pockets between the layers.

The completed filled food product may then be frozen into a substantially planar, rigid food product for later use or it could be further processed. For example, in one embodiment, the filled flatbread food product is baked or fried into a molded shape as previously discussed. For example, the filled flatbread food product could be molded in a pre-shaped taco frying basket to form a taco shell shape and then deep fried until crisp. Alternatively another method for molding the flatbread food product could include pan frying the product flat or in a folded configuration. In still further embodiments, the flatbread food product could be oven baked or microwaved into a desired shape. Once formed and heated the flatbread food product can be filled with a range of fillings such as but not limited to meat, cheese, vegetables and condiments.

Process 600 may be an automated process performed by a machine assembly or a manual process, or some combination of the two. Representatively, in one embodiment, a machine assembly may include a plurality of automated machines capable of, for example, applying a sealant, filler, a flatbread onto another flatbread, docking the flatbreads and applying a pressure to the flatbreads as they pass under the automated machines along a conveyor belt.

In the preceding detailed description, specific embodiments are described. It will, however, be evident that various modifications and changes may be made thereto without departing from the broader spirit and scope of the claims. For example, although a product having flatbread or tortilla shells is disclosed, it is contemplated that the shells between which a filling is sealed may have other shapes and sizes such that they form other types of food products having a filling sealed therein. Representatively, the shells may be in the form of tortilla chips, pita chips, crackers or the like such that the food product consists of chips or crackers having a filling sealed therein. The specification and drawings are, accordingly, to be regarded in an illustrative rather than restrictive sense.

What is claimed is:

1. A flatbread food product comprising:
a first flatbread having a first side and a second side;
a filling positioned on the first side of the flatbread;
a sealant positioned around edges of the first side of the first flatbread; and
a second flatbread having a first side and a second side, wherein the first side of the second flatbread faces the filling and is sealed to the first side of the first flatbread with the sealant such that the filling is sealed within the first flatbread and the second flatbread.

2. The flatbread food product of claim 1 wherein a surface of at least one of the first flatbread and the second flatbread comprises holes so as to prevent the formation of bubbles in the first flatbread or the second flatbread when heated.

3. The flatbread food product of claim 1 wherein the sealant is a food grade sealant capable of sealing the first flatbread to the second flatbread in the absence of heat.

4. The flatbread food product of claim 1 wherein at least one of the first flatbread and the second flatbread is a cooked tortilla.

5. A food product comprising:
a first layer comprising a first tortilla;
a second layer comprising a food filling applied to the first layer; and
a third layer comprising a second tortilla positioned over the second layer and sealed to the first layer using a food grade sealant applied around edges of the first layer such that the food filling is sealed between the first layer and the third layer.

6. The food product of claim 5 wherein a surface of at least one of the first tortilla and the second tortilla comprises holes so as to prevent the formation of bubbles in the first tortilla or the second tortilla when heated.

7. The food product of claim 5 wherein the food grade sealant comprises a starch from potato, wheat, rice, corn or other plant source.

8. The food product of claim 5 wherein at least one of the first tortilla and the second tortilla is cooked.

9. The food product of claim 5 wherein the food product is a fried food product having a substantially U shaped configuration.

10. The food product of claim 5 wherein the filling is the first filling, and the food product is cooked into a shape sufficient to hold a second filling.

11. A method of forming a filled flatbread food product comprising:
applying a food grade sealant to an exposed surface of a first flatbread layer;
applying a filling to the exposed surface of the first flatbread layer;
positioning a second flatbread layer over the first flatbread layer and the filling; and
applying pressure to one of the first flatbread layer and the second flatbread layer to seal the first flatbread layer to the second flatbread layer and around the filling.

12. The method of claim 11 wherein each of the first flatbread layer and the second flatbread layer are a tortilla.

13. The method of claim 11 wherein the filled flatbread food product has a substantially planar configuration.

14. The method of claim 11 further comprising:
docking one of the first flatbread layer and the second flatbread layer by adding a docking agent to a flatbread dough prior to forming the first flatbread layer or the second flatbread layer.

15. The method of claim 11 wherein applying pressure comprises applying pressure only around an outer edge of the second flatbread layer.

16. The method of claim 11 further comprising:
removing any air pockets between the first flatbread layer and the second flatbread layer by applying uniform pressure across an entire diameter of the filled flatbread food product.

17. The method of claim 11 further comprising:
freezing the filled flatbread food product to form a substantially rigid, circular shaped filled flatbread food product.

18. The method of claim 11 wherein the filling is a first filling, the method further comprising:
cooking the filled flatbread food product to form the filled flatbread food product into a shape having a pocket suitable for retaining a second filling.

19. The method of claim 18 wherein the shape is a U shaped configuration.

20. The method of claim 11 wherein each of the first flatbread layer and the second flatbread layer are cooked prior to forming the filled flatbread food product.
